(19) United States
(12) Patent Application Publication
(10) Pub. No.: US 2025/0193650 A1
(43) Pub. Date: Jun. 12, 2025

(54) EMERGENCY SYSTEM AND METHOD

(71) Applicant: Aliswe Corp, Dover, DE (US)

(72) Inventor: Berk GOZEK, Istanbul (TR)

(73) Assignee: Aliswe Corp, Dover, DE (US)

(21) Appl. No.: 19/051,192

(22) Filed: Feb. 12, 2025

Related U.S. Application Data
(60) Provisional application No. 63/700,789, filed on Sep. 30, 2024.

(30) Foreign Application Priority Data
Dec. 12, 2023 (TR) 2023/017113

(51) Int. Cl. H04W 4/90; G06Q 50/26; G08B 21/18; H04W 4/021

(52) U.S. Cl. CPC H04W 4/90; G06Q 50/265; G08B 21/182; H04W 4/021

(57) ABSTRACT

An emergency system and method monitor the health and safety of individuals living alone or in need of assistance on mobile platforms. The emergency system and method detect potential emergencies in advance by analyzing users' mobile device usage habits and the change history of the geolocation of the user's mobile device. A notification is transmitted from the emergency system to the user's mobile device to check on the user based on the usage and the geolocation information. The emergency system and method further detect situations that the user may be in need of immediate assistance, and automatically notify predetermined contacts and/or an official health institution that the user needs immediate attention.

### CROSS REFERENCE TO THE RELATED APPLICATIONS

This application claims priority to U.S. provisional application 63/700,789 filed on Sep. 30, 2024. This application further claims foreign priority to Turkish Patent Application No. 2023/017113, filed on Dec. 12, 2023, the entire contents of which are incorporated herein by reference.

### TECHNICAL FIELD

The invention relates to an emergency system and method developed for iOS or Android that will enable individuals living alone to be reached by sending a message or similar alert to these individuals from predetermined contacts, especially when the individuals are immobile and cannot reach their phones.

### BACKGROUND

With the rapidly advancing technology, emergency applications developed for the elderly play an important role in increasing their quality of life and ensuring their safety. These applications are specifically designed for quick and effective assistance, especially in an emergency. Emergency applications are equipped with several features to improve the safety of the elderly. Primarily, these applications allow the elderly to quickly call for help in an emergency at the touch of a button. This notification is automatically sent to predetermined persons, emergency services or their relatives. These applications can also detect the user's location. This feature allows relief teams or relatives to quickly reach the right location. In the event of an emergency, it is vital to determine the correct location and these applications offer a great advantage at this point.

Important information such as the medical history, prescriptions and emergency contacts of the elderly can also be made accessible through these applications. Thus, healthcare professionals or emergency teams can quickly access the necessary information. In addition, emergency applications are provided with easy-to-use interfaces and some of them are made workable by voice commands. These properties provide accessibility even for the elderly who are not accustomed to technology. As a result, the elderly can easily use these applications. These applications can also monitor the daily needs of the elderly. These features such as medication reminders and appointment follow-up enable the elderly to remember their daily routines and make their lives easier.

In a study conducted in Korea, it was mentioned that there is a risk of death of 1.5 million people at home alone. In another study conducted in Japan, it was determined that 4000 people died per week when they were alone at home. Studies have shown that the number of individuals living alone in the world is increasing day by day, especially after the COVID-19 pandemic. This rate is even higher in individuals 50 years of age and older. These individuals have a higher risk of death than other causes of death. Individuals who live alone also tend to live an anti-social life, and if these individuals do not receive support, they may face many problems such as depression, dementia, decreased mobility, and anxiety. Especially in people who stay at home alone, such situations may be encountered as they cannot reach their devices and ask for emergency help as a result of falling, fainting, any shock, anti-socialization, involvement in a dangerous event and similar events.

When all these are combined, emergency applications for the elderly are helped both to increase their safety and to maintain their independence. These applications are designed based on the special needs of the elderly and their adaptation to technology. In this way, the elderly can get timely help in emergencies and feel safer. In the current system, there are patent, utility model applications and/or various applications related to the subject. In the current system, the “find my phone” application on iOS-based phones determines the location of people. This application allows the lost or stolen phone to be found, the device to be locked remotely, and the contents to be deleted. This application works if the device has an internet connection. It shows the location of the device on the map and indicates its final location to the user. This helps to find the lost or stolen phone. The “screen time” application on iOS-based phones determines how long the user's phone is used, and the “health/step” application determines the time when the user is on the move and walking.

A device belonging to AFAD allows the user to make an emergency call by pressing the button on it in case of need of help. The device can be used when the user is accessible and conscious. The application called Chk-In fall alert is designed in such a way that if the device detects sudden movement as when falling, it is perceived as a fall. In such a case, it sends a call for help to the people on the emergency contact list. The device must be carried by the user to use the application. The application called Dele-Health-tech-Fall alerts works similarly to the application called Chk-In fall alert. The duration of how active the user is in the specified applications has been calculated. In order to use these applications, the device must be carried by the individual and the individual must be conscious to operate the device.

The patent application numbered “TR2018/17249” in the state of the art relates to a person tracking system that can be used for the safety and protection of persons who need to be kept under surveillance such as children, elderly, mentally disabled and Alzheimer's patients in all kinds of areas whose boundaries can be determined such as home, nursery, workplace, public area, park, and garden. A danger sensor integrated into any smart accessory such as a wristband, watch or necklace on the person to be tracked monitors signals from tracking sensors placed in dangerous areas or in safe areas that define the boundaries of a home or school. If the specified limit distances are exceeded, the danger sensor sends an alert to the smart device of the responsible person and thus the person is warned. In said invention, there is also a mobile application that is installed in mobile devices, where the person to be followed can be followed instantly through the smart accessory, where the safe/dangerous distance information for each tracking sensor can be defined to the smart accessories (2) and notifies the person in charge of the alerts from the danger sensor.

Patent application “US2013065569A1” in the state of the art relates to a system and method for remote care and monitoring and, more specifically, for remote care and monitoring of the user of a mobile device such as a smartphone and for simplifying the use of the mobile device. The invention provides a unique software solution and method to facilitate the use of a mobile smartphone device while also allowing authorized users (e.g., care providers, related family members) to interact remotely with the mobile user and provide them with medical care information on a daily basis. In cases where the mobile phone user does not actively answer the phone, press any button, or initiate any other type of activity, the relevant person is informed. The mobile device is configured to transmit information about the activity and inactivity of the first user to the second user. The server is configured to transmit information about the activity and inactivity of the first user to a third party.

However, the conventional technologies do not automatically notify the care providers or family members that the user may need immediate assistance when the user is immobile and/or cannot reach the phones. As a result, a new technology is needed in the relevant field due to the disadvantages described above and the inadequacy of the current solutions on the subject.

### SUMMARY

The objective of the invention aims to develop a comprehensive algorithm to monitor the health and safety of individuals living alone or in need of assistance on mobile platforms. The invention detects potential emergencies in advance by analyzing users' mobile device usage habits and current locations, and to ensure timely interventions when necessary.

The invention relates to an emergency system developed for iOS or Android that will enable individuals living alone to be reached by sending a message or similar alert to these individuals from predetermined contacts, especially when the individuals are immobile and cannot reach their phones.

The object of the invention is to provide information to predetermined contacts in cases where individuals living alone are not able to operate their phones but need immediate attention. In this way, it is ensured that the awareness of the contacts increases in the intense life tempo they have, and support and assistance is provided to individuals living alone.

Another object of the invention is to determine how inactive the person is in their routine life, to intervene and take measures to avoid such situations to cause other troublesome situations.

Within the scope of the invention, two main user groups have been defined: “Beta” and “Alpha”. Beta users refer to the individuals who monitor the mobile device usage and location data of Alpha users and oversee their well-being. Alpha users refer to elderly individuals or those in need of assistance and are monitored through their mobile device usage data and current location.

The basic principles of the algorithm are as follows:

Mobile Device Usage Monitoring—The mobile device usage times of Alpha users are analyzed based on active and passive periods outside of their sleep hours. As a result of this analysis, a threshold value is created. When a deviation exceeding this threshold is detected in the user's usage time, an alert is sent to Beta users. This alert ensures that the Alpha user is physically checked, allowing timely intervention for potential health issues or emergencies.

Location Tracking and Safe Zone—The current locations of Alpha users are continuously monitored, and a “safe zone” is defined, which the user specifies. The safe zone encompasses an area like the user's street, neighborhood, or district. If the Alpha user moves outside of this designated safe zone, an alert is sent to Beta users. This system aims to reduce risks such as getting lost and to enhance the user's safety.

The goal of the instant invention is to monitor individuals based on both mobile device usage habits and location data to increase the safety and well-being of the individuals who live alone or are in need of assistance. By ensuring that the users/individuals remain within safe zone boundaries and achieving early detection of abnormal mobile device usage, and timely alerting the contacts for possible emergencies.

### BRIEF DESCRIPTION OF THE DRAWINGS

FIG. 1 illustrates the emergency system of the instant invention

FIG. 2 illustrates a usage routines graphic user interface of the emergency system.

FIG. 3 illustrates a location graphic user interface of the emergency system.

FIG. 4 illustrates a help button graphic user interface of the emergency system.

FIG. 5 illustrates a notification graphic user interface of the emergency system.

FIG. 6 illustrates a setting graphic user interface of the emergency system.

FIG. 7 illustrates a float chart to determine the sleep data of the user.

FIG. 8 illustrates a float chart to trigger an alarm based on the sleep data of the user.

FIG. 9 illustrates a float chart of a sleep hours derivation algorithm.

FIG. 10 illustrates a float chart to determine alarm duration and sharpness.

FIG. 11 illustrates a continued float chart to determine alarm duration and sharpness.

FIG. 12 illustrates a float chart for triggering an alarm based on the determination of the alarm duration and sharpness.

### ELEMENT NUMBERS SPECIFIED IN THE FIGURES

In order to better explain the system developed by this invention, the parts and elements in the figures are numbered and the corresponding numbers are given below:
1. Usage routines module
2. Location routines module
3. Health routines and fall alerts module
4. Call for help module
5. Notification module
6. Settings module

### DETAILED DESCRIPTION OF THE EMBODIMENTS

The invention relates to a smart device system that enables individuals living alone to be reached by a predetermined contact sending a message or alert to these individuals, especially when the individuals are immobile and cannot operate their phones. The system detects the average or maximum times when they do not use the smart device or when the smart device does not detect movement, and when it exceeds these time frames, it works on the principle of sending an alert message to the other party. These periods can also be entered manually when desired. The invention also enables the user to get help with the data to be given to the contact person(s) they have determined, as it will be an indication that the user has started to establish less connection with the outside world in cases where the location they have designated as “home” does not exceed a diameter to be determined. Due to the intense living conditions, the user's contacts reach the users 1-2 times a week in their routine lives. In these cases, which are unconscious and threaten human health, reaching the user with early intervention and providing the necessary help increases the chance of survival of the user.

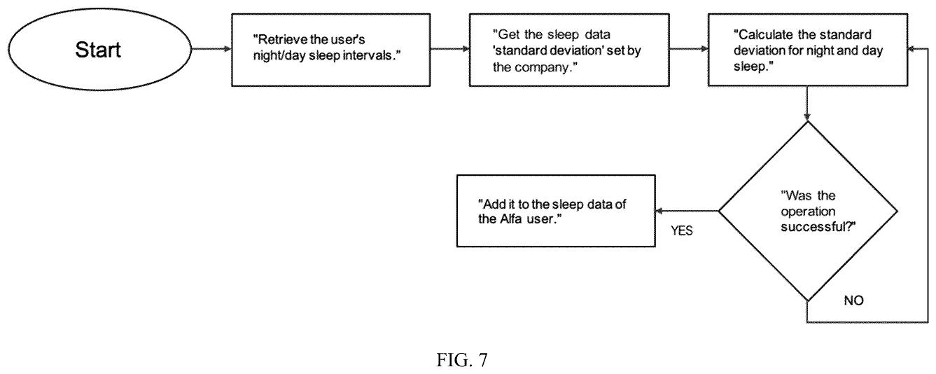

The emergency system includes a mobile device 200 configured to track a user's activities, a server 100 in communication with the mobile device, and a notification device 300 to receive notifications about the user from the server. The server includes a usage routines module (1), a location routines module (2), a health routines and fall alerts module (3), a call for help module (4), a notification module (5) and a settings module (6). These modules are software algorithms stored in a non-transitory computer readable medium (i.e. data storage) of the server and when executed by a processor of the server, perform the associated processes as will be discussed below in FIGS. 7-12. In the system developed with the invention, the contacts are determined first.

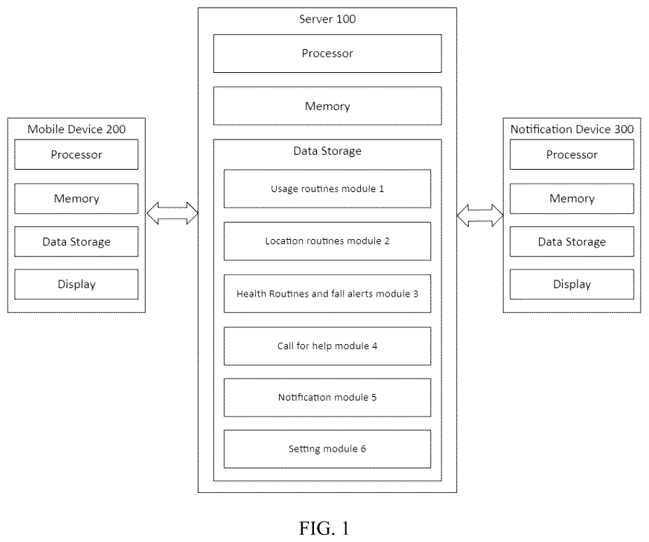

FIG. 1 illustrates the emergency system including a server 100, a mobile device 200, and a notification device 300. The server 100 includes a processor, a memory, and a data storage storing the usage routines module (1), the location routines module (2), the health routines and fall alerts module (3), the call for help module (4), the notification module (5) and the settings module (6). The mobile device 200 includes a processor, a memory, a data storage, and a display, and the mobile device 200 communicates with the server 100 through a wireless network. The notification device 300 includes a processor, a memory, a data storage, and a display, and the notification device 300 communicates with the server 100 through another wireless network.

The user of the mobile device 200 creates an emergency contact list consisting of people (such as neighbors, apartment attendants) who can reach them quickly or provide support from other people around them. These emergency contacts can usually be from other family members or a group of close friends. It is important that the selected contacts consist of sensitive people.

The use routines module (1) does not need to be on the smart device or on the user for it to work. The usage routines module (1) on the server 100 determines the average and maximum downtime within days/weeks/months. If the user exceeds these periods, it is assumed that there is a certain problem due to reasons such as health, the user cannot reach the device, and is in an unconscious state. These situations may occur as a result of falling, fainting, any shock, involvement in a dangerous event and similar events. In these cases, which are unconscious and threaten human health, reaching the user with early intervention and providing the necessary help increases the chance of survival of the user.

The usage routines module (1) detects the downtime that goes beyond the daily/weekly/monthly routine and creates anomalies, sends an alert message to the contact persons previously determined by the user, and enables the device owner to be reached and checked on. These time frames can also be entered manually optionally. The chance of preventing adverse situations that may occur with a possible early intervention increases. The usage routines module (1) works according to the principle of not using the phone for a long time in which time zone of the day by collecting the times when the phone is turned off. People do not use smart devices that are constantly in their hands during the day for a long time in special situations such as when they sleep, study, take an exam, or work. Still, when they wake up, they first look at their phones in situations such as when a meeting ends. When the phone is not used in the usage routines module (1), but if there are situations on another device, the active device is also connected to the system (application) with Bluetooth and the data is collected simultaneously. For example, when the application on the car is connected over the phone, the phone is not actively in use because the car is being used at the time. As another example, in the case of working on smartwatch platforms, different algorithms are created with the information obtained from this platform to ensure that the system works more effectively.

The standard non-use time of the smart device is collected by the usage routines module (1) on a daily, weekly, and monthly basis. The time during the day is divided into two as the awake period and the asleep period. Here, the area where the density of non-use occurs in the data collected over time is defined as the sleeping area. While the period of non-use in the sleeping area is longer according to the collected data, the period of non-use in the waking area is shorter. These periods are created over time by collecting data in the application. These periods of non-use to be calculated by the application are defined as “personal non-use period.”

On the other hand, the system is designed to operate on the data entered by the user (personal data, contact person(s) information, non-use periods) from the settings module (6). The default data is entered by the user themselves, while the personal data is calculated by the system in the background. Thus, if there is an increase in the differentiation between the routine that the user knows and the periods determined by the application, then it is ensured that the user and emergency contacts draw their attention. The default settings and personal settings can be as in the table below.

TABLE 1
Default and Personal Settings Example Table

| | |
|---|---|
| Awake | Asleep |

| | | |
|---|---|---|
| Default time frame | 10:00-23:00 | 23:00-10:00 |

| | | | | |
|---|---|---|---|---|
| Default non-use time | 3 | Hours | 9 | Hours |
| Default emergency non-use time | 5 | Hours | 11 | Hours |

| | | |
|---|---|---|
| Personal time frame | 09:00-01:00 | 01:00-09:00 |

| | | | | |
|---|---|---|---|---|
| Personal non-use time | 1.5 | Hours | 5 | Hours |
| Personal emergency non-use time | 3.5 | Hours | 7 | Hours |

The notifications to be sent vary according to the level of importance. These notices are as follows:

TABLE 2
Notification Example Table

| | | Importance | | Notification | |
|---|---|---|---|---|---|
| Cause | Status | Level | Reason | Color | Notification Tone |
| Being unable | When the phone | 2 | To draw | Blue | Voice message beginning |
| to reach user | is switched off | | attention | | with “alert” on the screen |
| Being unable | When the phone | 2 | To draw | Blue | Voice message beginning |
| to reach user | is switched to | | attention | | with “alert” on the screen |
| | flight mode | | | | |
| Being unable | When battery | 2 | To draw | Blue | Voice message beginning |
| to reach user | level drops | | attention | | with “alert” on the screen |
| | below 10% | | | | |
| Being unable | When the | 2 | To draw | Blue | Voice message beginning |
| to reach user | cellular data is | | attention | | with “alert” on the screen |
| | turned off | | | | |
| | At the end of the | 4 | To draw the | Pink | Voice message beginning |
| | standard non-use | | attention of the | | with “Are you okay?” on |
| | time | | user | | the screen* |
| | When the | 3 | For general | Green | Message on the screen |
| | standard non-use | | information | | |
| | time exceeds 30 | | purposes | | |
| | minutes | | | | |
| | At the end of the | 2 | To draw | Blue | Voice message beginning |
| | maximum | | attention | | with “alert” on the screen |
| | emergency non- | | | | |
| | use time | | | | |
| | When the | 1 | When it is | Red | Continuous audible alarm |
| | maximum | | assumed that | | |
| | emergency non- | | there is a | | |
| | use time exceeds | | dangerous | | |
| | 1 hour | | situation that | | |
| | | | the user is in or | | |
| | | | when the user | | |
| | | | is not reached | | |
| | When the | 0 | Making an | Orange | Playing an automatic voice |
| | maximum | | official | | message by calling |
| | emergency non- | | emergency call | | emergency help |
| | use time exceeds | | when the | | |
| | 3 hours | | phone is | | |
| | | | unused for a | | |
| | | | long time, | | |
| | | | even if the | | |
| | | | emergency | | |
| | | | contact is | | |
| | | | reached | | |
| | | | (optional) | | |
| | When the phone | 3 | For general | Green | Message on the screen |
| | is connected to | | information | | |
| | another vehicle | | purposes | | |
| | via Bluetooth | | | | |

Since the user will pick up the phone when this feature is presented to the user, the calculation period of the system starts from the beginning.

It is another indication that the user has started to establish less connection with the outside world if the determined area does not exceed a certain diameter area. It is important to support the user in this case. The phone must be on and carried by the user for the location routines module (2) used for this purpose to work. The current location (i.e. geolocation) of the user is determined by GPS technology embedded in the phone. In case of not going out of the location by means of the location routines module (2), it can be ensured that the user is notified whether there is a problem or not. These notifications can also be sent to the contacts to be determined.

In order for the location routines module (2) to be set, it is first entered into the user's “home” location settings module (6). By means of the location routines module (2), daily location routines are collected by reporting how often and how far the user is from the area. In this system, the location is defined as three areas as shown below:

TABLE 3
Areas

| Location | Definition |
|---|---|
| Home | Places within 100 meters of home |
| Area of | Places that can be entered depending on the |
| residence | user's own information and have a diameter |
| | of 2 kilometers by default |
| Out of the area | Places 2 kilometers out of home |

The farthest distance made during the day by the location routines module (2) and the information that this distance is home, area, out-of-area, information that it is below the week average, how many days at home, how many days in the same area, how many days out of the area are collected. There are different algorithms for collecting this information. For example, when the user does not go out of the area during the week, the level of importance is 2, when they do not go out of the area 3 times in a row during the week, the level of importance is 1, or a notification is sent in cases where they do not go out of home on the 3rd, 5th, 7th day in a row according to the level of importance. Instant notification is received when the user goes out of the area, and thus, if the user using the application is an elderly person, the emergency contacts are informed when the user goes to a remote area. The notifications to be given vary according to the level of importance. These notifications are as follows:

TABLE 4
Notification Examples Table

| | Importance | | Notification | | |
|---|---|---|---|---|---|
| Notification | Level | Reason | Color | Notification Tone | |
| The farthest distance | 3 | For general | Green | Message on the screen | |
| during the day, | | information | | | |
| information that this | | purposes | | | |
| distance is home, area, | | | | | |
| out-of-area | | | | | |
| Information that it is | 3 | For general | Green | Message on the screen | |
| below the week average | | information | | | |
| | | purposes | | | |
| Information on how | 3-2-1 | Depending on | Blue | | |
| many days at home, how | | situation | | | |
| many days in the same | | | | | |
| area, how many days out | | | | | |
| of the area | | | | | |
| Instant notification that | 2 | To draw attention | Green | Voice message | |
| the user has gone to a | | | | beginning with “alert” | |
| remote area when going | | | | on the screen | |
| out of the area | | | | | |
| When the user does not | 3 | For general | Green | Message on the screen | To emergency |
| go out of home for 3 | | information | | | contacts and the |
| consecutive days | | purposes | | | user, |
| | | | | | themselves* |
| When the user does not | 2 | To draw attention | Blue | Voice message | To emergency |
| go out of home for 5 | | | | beginning with “alert” | contacts and the |
| consecutive days | | | | on the screen | user, themselves |
| When the user does not | 1 | When it is | Red | Continuous audible | To emergency |
| go out of home for 7 | | assumed that there | | alarm | contacts |
| consecutive days | | is a dangerous | | | |
| | | situation that the | | | |
| | | user is in or when | | | |
| | | the user cannot be | | | |
| | | reached | | | |

Thus, the user is thought to have gone out so that the message is not sent to the emergency contact person.

When the device is not used, the alert/message system, the usage routines module (1) and the location routines module (2) are used to collect data on how often the user uses their smart device in certain time zones, and the average non-use times and maximum usage time are determined in different time periods by the calculations they make themselves. With the weekly/monthly alert system, the system calculates the average usage times with the data collected through the usage routines module (1). If the user uses the smart device less than routine, an information message is sent to the contact persons about the situation, as it will be an indication that they have started to establish less connection with the outside world.

Users sometimes use smart devices more and sometimes less during the day. These smart devices can be phones, tablets, or smart watches. The developed system determines the average or maximum downtime within days/weeks/months through the usage routines module (1). If the user exceeds these periods, it is assumed that there is a certain problem with them, they cannot reach the device, and are in an unconscious state. These situations may occur as a result of falling, fainting, any shock, involvement in a dangerous event and similar events.

Smart devices also provide users with connections to the outside world. If the routine average downtime calculated by the usage routines module (1) and the location routines modules (2) in the system increases, this is a sign that the user has started to establish less connection with the outside world. It is important to support the user in such cases. The system (application) on the smart device sends an alert message to the contact persons whom it has previously determined that there is no use other than the daily/weekly/monthly routine through the application it creates according to the data received from the usage routines module (1) and the location routines modules (2) and enables the device owner to be reached and checked on. These time frames can be created according to the data received from the usage routines module (1) and location routines modules (2) operated by a processor as specified, as well as optionally entered manually. In this way, a user-specific control mechanism can be developed. For example, if a user checks their smart device at 2-hour intervals per day, this use is processed by the usage routines module (1). If no smart device is used for more than 2 hours, an alert message is sent to the contact persons. Similarly, the user can also manually set this time frame to 2 hours. Likewise, the user can manually define the place where they spend the most time through the system. In addition to making a manual entry, the user can also use the application developed with the invention to determine the place where they spend the most time using the location routines module (2).

The system developed with the invention determines that the user turns the device on and off every 2 hours on average, at the latest at the end of 3 hours, and the sleeping time is maximum 8 hours between 8:00-24:00 hours when the user is awake. If the user has exceeded the average time of 2 hours, the system will first send the user “Is everything okay?” message in which they can simply respond to the “OK” button. If the user replies to the message, the time count starts again after turning off the device. If the user does not respond to the message, a message is sent to the contact person 5 minutes after the average time has passed. It is ensured that the contact person has information about the situation and thus they are in a follow-up situation. If the user exceeds the maximum time, which is 3 hours during the day determined by the system and 8 hours during sleeping, an alert in the form of a loud alarm and message is sent to the user this time, thus attracting the attention of the user. If the user replies to the message, the time count starts again after turning off the device. If the user does not respond to the message, the same loud alarm and message are sent to the contact person after 5 minutes. In this case, the contact person is trying to reach the user. If the perception of the contact person cannot be captured by the system, after 2 hours after these maximum periods, the device makes an “118 Emergency” call with an automatic voice message about the situation.

The chance of preventing adverse situations that may occur with a possible early intervention increases. As specified, the location routines module (2) is defined as the user's location “home”. Since it is another indication that the user has started to establish less connection with the outside world if this area does not exceed a certain diameter area, it may be necessary to support the user. In this case, an alert is sent to the contact persons if the location routines module (2) operated by a processor does not exceed a certain diameter area or goes to an unspecified location. This specified alert can be via message, notification, or an audible alert. Data on how often the user goes far from this location on a daily/weekly/monthly basis are shared with the contact persons. If this data, which is shared weekly and monthly, shows a decrease with previous data, it is an indication that the user tends to be anti-social. If the specified minimum diameter of this location is never exceeded on a weekly basis, an audible alert is sent to the contact person. A higher awareness of the contact person is achieved.

As stated above, it is ensured that a notification is received whether there is a problem or not in case of timeouts determined in the system or in case of not going out of the location. These notifications are also sent to the contacts to be determined. If there is an extreme situation in case of these specified periods or inactivity, the module can automatically prepare a voice message summarizing the situation and call the emergency unit (for example, 118,112) in the area where the system is used through the call for help module (4). The call for help module (4) enables the inability to reach the emergency assistance unit in the area where the system is used, or the situation detected in the user to be explained with an automatic message in case the emergency contacts cannot be reached.

The phone must be on and carried by the user for the health routines and fall alerts module (3), which is another module with the system, to work in the system developed with the invention. The health routines and fall alerts module (3) is intended to inform and warn emergency contact persons in important situations related to the user. The health routines and fall alerts module (3), which is operated by a processor, collects data, and sends an alert message to the contact person in cases where the user falls, the heart rate is impaired, the amount of daily walking is reduced, the time spent asleep, the sound around them increases suddenly or there is silence for a predetermined period of time. The user or contact person can adjust these silence periods. In the event of falling down, monthly fall figures are collected by the health routines and fall alerts module (3) as well as an alarm as soon as they fall. Because it is thought that there is a problem in a user who falls more than 3 times a month and should be controlled. In such a case, information is sent to both the user themselves and their emergency contacts.

The phone must be on, and the user must be nearby for the call for help module (4) to work. When the smart device is turned off, the phone is put into flight mode, the battery level drops below 10%, the cellular data is turned off, the phone is out of range or the phone is inoperative, a message is sent to the emergency contacts through the call for help module (4). The user can send notifications to their emergency contacts using the call for help module (4). This module is also accessible through the artificial intelligence module of the phone, such as “Hey, Siri!”. The notifications to be given vary according to the level of importance and these notifications are as follows:

TABLE 5
Notification Examples Table

| Notification | Importance | | Notification | Notification | |
|---|---|---|---|---|---|
| Type | Level | Reason | Color | Method | Notified Person |
| When pressed | 1 | When it is assumed | Red | Continuous | To emergency contacts |
| once | | that there is a | | audible alarm | |
| | | dangerous situation | | | |
| | | that the user is in or | | | |
| | | when the user is not | | | |
| | | reached | | | |
| When pressed | | Voice call | | Group calls to | To emergency contacts |
| twice | | opportunity for | | people in the | |
| | | anyone who connects | | emergency | |
| | | via group call | | contact | |
| When pressed | 0 | Making an official | Orange | | Playing an automatic |
| 3 times | | emergency call if | | | voice message by |
| | | even the emergency | | | calling official |
| | | contact cannot be | | | institutions |
| | | reached (optional) | | | |

The phone must be on and near the user for the notification module (5) to work. The notification module (5) is located for the purpose of viewing general information messages and if the system is installed by the emergency contact person, both their notifications and the notifications of the people who add them as an emergency contact can be seen. Monthly/weekly/daily/specific day messages can be selected from the notification module (5) through filtering. In addition, messages related to location/fall/use/health status can be selected through filtering. In addition, messages belonging to different people can be selected through filtering. Thus, since it would be an alternative to see the notifications made at certain times in different structures, if the routines of the person using the application change, it can be considered to take precautions by observing them.

In the settings module (6), there is general information about the user and general settings related to the application. The notifications to be given in the settings module (6) can be graded according to their importance. According to the level of importance, it can be ensured that the notification messages given draw the attention of the emergency contacts in different ways. The following table shows the different notification tones and colors according to the level of importance.

TABLE 6
Alert Examples Table

| | Importance | | Notification | Notification | To whom to send a |
|---|---|---|---|---|---|
| Settings Type | Level | Reason | Color | Tone | message |
| Alert settings | 0 | Making an official | Orange | | Playing an |
| | | emergency call if | | | automatic voice |
| | | even the emergency | | | message and calling |
| | | contact cannot be | | | the official |
| | | reached (optional) | | | institution. |
| Alert settings | 1 | When it is assumed | Red | Continuous | To emergency |
| | | that there is a | | audible alarm | contacts |
| | | dangerous situation | | | |
| | | that the user is in or | | | |
| | | when the user cannot | | | |
| | | be reached | | | |
| Alert settings | 2 | To draw attention | Blue | Voice message | To emergency |
| | | | | beginning with | contacts and the |
| | | | | “alert” on the | user, themselves |
| | | | | screen | |
| Alert settings | 3 | For general | Green | Message on | To emergency |
| | | information | | the screen | contacts and the |
| | | purposes | | | user, themselves |
| Alert settings | 4 | To draw the | Pink | On the screen, | The user themselves |
| | | attention of the user | | a voice | |
| | | | | message | |
| | | | | beginning with | |
| | | | | “Are you | |
| | | | | okay?” | |

The system developed with the invention is intended to detect situations in which the user is not active in his/her routine life and to intervene and take measures to prevent such situations from causing other distressing circumstances. Since the system, which includes the usage routines module (1), the location routines module (2), the health routines and fall alerts module (3), the call for help module (4), the notification module (5) and the settings module (6), works according to the principle of the smart device not being used, it is not a problem that the user does not have access to the device or is unconscious in the alert messages to be sent to the other party. In the location routines module (2), which determines the status of not going outside the location of the system, data on how far it goes to the point it is located on a daily/weekly/monthly basis are determined.

The system especially targets phone users who live alone and are included in the health problems or high age group and users who can be reached by these users in case of emergency. When users included in such high-risk groups encounter traumatic situations such as falling, fainting, accident, etc., they sometimes cannot inform contact persons for days, as they do not have a person with them to report this situation. This situation leads to permanent damage or death. For example, if a user included in the risk group, who meets with their relatives with an average frequency of 3 days, falls at home the next day of getting together and cannot get up from where they fell due to fainting, coma, orthopedic fracture, etc., it takes at least 2 days for their relatives to be notified regarding the emergency and this situation emerges as another irreparable problem. Among the secondary goals that this system will benefit, target groups such as those who go on long-term nature walks alone, or go on long-term business trips, etc. can be added.

In addition, the data collected by this program can be shared with health organizations on request, as it can shed light on studies such as the changes in the routines of certain age groups and people living in certain regions.

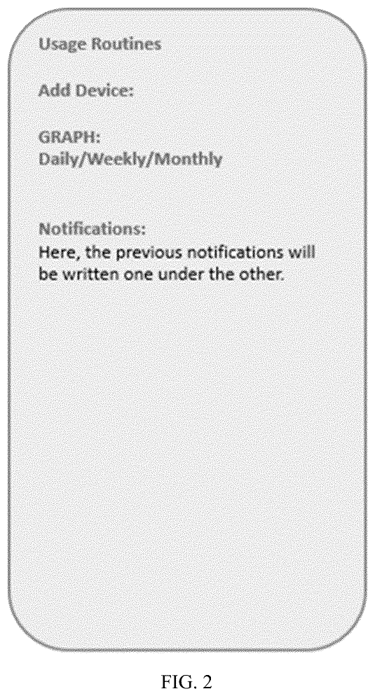

FIG. 2 illustrates a usage routines graphic user interface of the emergency system. The usage routines graphic user interface is displayed on both the mobile device 200 and the notification device 300. For the mobile device 200, the usage routines graphic user interface enables the user to add a list of notification devices in which the user would like to notify. The user can also view his/her usage on a daily, weekly, and monthly basis. Also, the user is able to view current and previous notifications sent and received on the mobile device. For the notification device 300, the graphic user interface on the notification device 300 allows a caregiver to also view the list of notification devices being added, the user's usage on a daily, weekly, and monthly basis, and the current and previous notifications sent and received on the mobile device.

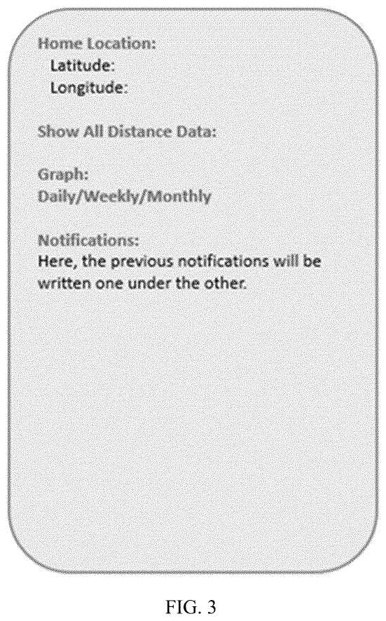

FIG. 3 illustrates a location graphic user interface of the emergency system. The location graphic user interface is displayed on both the mobile device 200 and the notification device 300. For the mobile device 200, the location graphic user interface enables the user to set and view a home location. The user can also view his/her distance data with respect to the home location on a daily, weekly, and monthly basis. Also, the user can view current and previous notifications sent and received on the mobile device. For the notification device 300, the graphic user interface on the notification device 300 allows a caregiver to also view the set home location, the user's distance data on a daily, weekly, and monthly basis, and the current and previous notifications sent and received on the mobile device.

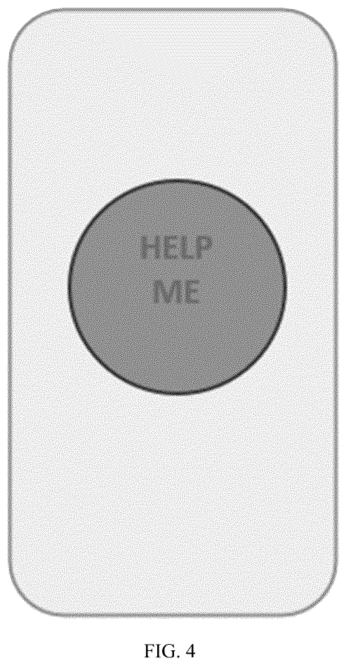

FIG. 4 illustrates a help button graphic user interface of the emergency system. The help button can be triggered by the user of the mobile device. Depending on the times that the help button is pressed by the user, the mobile device will transmit a message to the server as discussed above in Table 5.

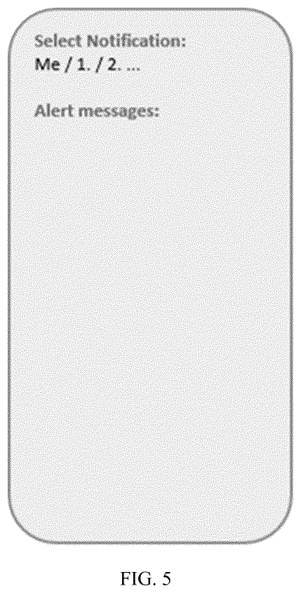

FIG. 5 illustrates a notification graphic user interface of the emergency system. The notification graphic user interface is displayed on both the mobile device 200 and the notification device 300. For the mobile device 200, the notification graphic user interface enables the user to view current and previous alerts. For the notification device 300, the notification graphic user interface on the notification device 300 allows a caregiver to also view the current and previous alerts.

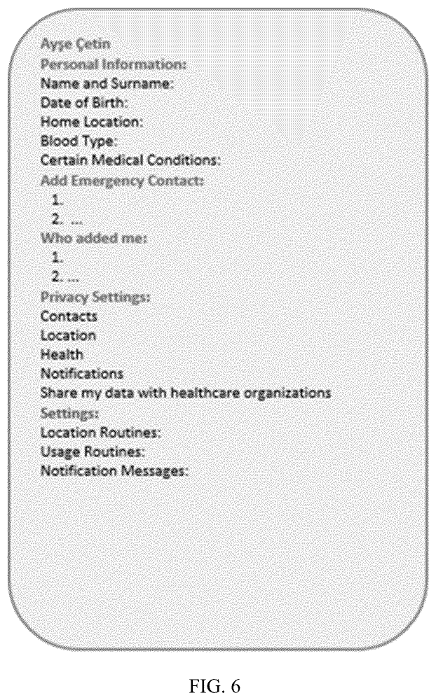

FIG. 6 illustrates a setting graphic user interface of the emergency system. The setting graphic user interface is displayed on the mobile device 200. The setting graphic user interface enables the user to enter personal information, add emergency contacts, view a list of contacts that added the user, and adjust settings for location, usage, notification, and privacy.

### Technological Infrastructure

### Mobile Platforms:

### Android and iOS

### Technologies Used:

Laravel: A PHP framework used for server-side application development.
MySQL: A database management system.
Kotdin: A programming language used for Android application development.
JSON: A data format.
RESTful API: A service that enables data exchange between the server and the client.
Swagger: A tool used for documenting and testing RESTful APIs. It is used to define API endpoints and help users understand the API easily.
Swift: A programming language used for iOS application development.
Firebase Cloud Messaging (FCM): It is used to send push notifications to applications.

### User Types

OMEGA
   Definition: The person who purchases the application and shares it with beta users.
   Task: Purchases the application and initiates the process of starting the application and setting up user relationships.
   System Relationship: Apart from purchasing the application, Omega functions the same as a beta user.
BETA
   Definition: The user who steps in when there is no response from the Alpha user.
   Task: Steps in if the Alpha user does not respond to the alert.
   System Relationship: Beta is called into action if Alpha remains unresponsive.
ALPHA
   Definition: The user who receives the initial alert. If this user does not respond, the process continues.
   Task: Receives the initial alert and is expected to respond at the first stage of the system.
   System Relationship: If Alpha remains unresponsive, Beta is involved.

### Periods and Sleep

Acper
Refers to the period during which the user is active.
Siper
Refers to the periods outside of Acper, meaning the time when the user is not active.
Night Sleep
The approximate sleep time range determined by the user.
Daytime Sleep
The approximate sleep time range determined by the user.
Sleep Deviation Interval
Added to the sleep durations, determined by the company (i.e. server administrator).
Max Sleep Time
The total time determined by the user, including the sleep deviation interval set by the company.

### Warning Systems

Alpha Emergency Call
This system is triggered by the user via the application and bypasses the algorithm, starting an emergency alert notification.
Emergency Warning System
This is an algorithm that processes Siper data through necessary operations and automatically initiates the alert system if it determines that the Alpha user may need assistance.
Safe Zone Warning System
This system provides various functions to ensure the safety of elderly or individuals living alone. Notifications are sent to Beta users (family members or caregivers) when the user moves outside the safe zone or remains inactive for a prolonged period. Additionally, the system aims to fulfill the following functions to support personal health and safety:
   Emergency Response
   Provides rapid intervention by sending emergency alerts when the user suddenly moves away from the safe zone or remains inactive for a long time.
   Daily Activity Monitoring
   Monitors the user's movements and shares information with family members or caregivers when unusual situations are detected.
   Health Recommendations
   Provides reminders and suggestions that encourage the user to go outside regularly and exercise.
   Social Interaction Encouragement
   Detects the lack of social interaction and suggests social activities or encourages the user to communicate with family members.

### Databases:

### Acper Data

This data group contains the start and end times of interactions that the Alpha User has with their mobile device throughout the day, as well as the types of interactions.

### Siper Data

Represents the opposite of the interaction periods in the Acper table and records the periods when the Alpha User is not interacting. This table contains the times before the interaction starts and after it ends.

### Location Data

This data contains the Alpha's location information, which is stored at specific intervals.

### Safe Zone Data

This data defines a safe zone determined by Beta for the Alpha user within their living area. For example, this data may cover an area with a radius of 1 km around the living space.

### User Data

This data contains personal information of Omega, Alpha, and Beta users.

### Sleep Data

This data contains information about the sleep hours of the Alpha user.

### Sleep Deviation Data

This data contains deviation information added to the sleep data of the Alpha user or the persona group the Alpha belongs to, based on criteria set by the company.

### Beta Data

This data contains personal information and analysis data of the Alpha users that Omega and Beta users are tracking.

### Alpha Data

This data contains personal information of Omega and Beta users who are tracking the Alpha user.

### Persona Group Data

This data group is created by considering personal characteristics like the age, gender, region, and habits of the Alpha user. These groups are compared with other Alpha users, and their sleep data is compared with those in similar profiles. In this way, the closest deviation data to the Alpha user's sleep data is determined and analyzed.

### User Relationship Data

This data stores information about the relationship status between Omega, Beta, and Alpha users.

### Interaction Data

This data covers the interactions that Alpha users have under the following interaction types:
When the phone is unlocked and used.
When the phone is answered during incoming calls.
When an incoming call is received but not answered.
When the screen is activated but the phone is not unlocked.

These data are stored to detail the situations in which users interact with their phones.

### Data Fields:

1. Data fields used for Acper Data:
   activeperiods
   id: This is the primary key data.
   deviceId: The globally unique device data of the user.
   uuid: The globally unique identifier of the user.
   sleeping: This data indicates whether the user is in a sleep state.
   startTime: This is the data for the interaction start time of the user.
   endTime: This is the data for the interaction end time of the user.
   acperDurationMins: This is the data for the duration difference between the start and end times of the interaction.
   reportType: This data contains information about the type of interaction the user had.
   created_at: This field contains the data creation time.
   updated_at: This field contains the data update time.
2. Data fields used for Siper Data:
   silent_periods
   id: This is the primary key data.
   deviceId: The globally unique device data of the user.
   uuid: The globally unique identifier of the user.
   sleeping: This data indicates whether the user is in a sleep state.
   startTime: This is the data for the start time after the end of the user's previous interaction.
   endTime: This is the data for the start time of the user's new interaction.
   siperDurationMins: This is the data for the duration difference during the non-interaction period.
   reportType: This data contains information about the type of interaction the user had.
   created_at: This field contains the data creation time.
   updated_at: This field contains the data update time.
3. Data fields used for Location Data:
   location history_logs
   id: This is the primary key data.
   deviceId: The globally unique device data of the user.
   uuid: The globally unique identifier of the user.
   lat: Contains the latitude data of the user.
   lng: Contains the longitude data of the user.
   created_at: Contains the data creation time.
   updated_at: Contains the data update time.
4. Safe Zone Data—User Safe locations:
   id: This is the primary key data.
   uuid: The globally unique identifier of the user.
   circleLat: Contains the latitude radius data of the user's safe zone.
   circleLng: Contains the longitude radius data of the user's safe zone.
   created_at: Contains the data creation time.
   updated_at: Contains the data update tim
5. User Data & Data Fields:
   Users
   id: This is the primary key data.
   uuid: The globally unique identifier of the user.
   name: Contains the user's name.
   surname: Contains the user's surname.
   email: Contains the user's email address.
   password: Contains the user's password.
   email_verified_at: Contains the user's email verification data.
   remember_token: Contains the token data needed for remembering the user.
   created_at: Contains the data creation time.
   updated_at: Contains the data update time.
   Userdetails
   id: This is the primary key data.
   uuid: The globally unique identifier of the user.
   uuid_beta: The globally unique identifier of the Beta user.
   phoneNumber: Contains the user's phone number.
   nickName: Contains the user's nickname.
   gender: Contains the user's gender information.
   city: Contains the user's city information.
   isAlpha: Indicates whether the user is an Alpha user.
   warning: Contains the data returned from the warning system.
   sensitiveLvl: Contains the sensitivity data in the warning system as determined by the company.
   created_at: Contains the data creation time.
   updated_at: Contains the data update time.
6. Sleep Data & Data fields used:
   User_sleeping_lists
   id: This is the primary key data.
   uuid: The globally unique identifier of the user.
   sleepingType: Contains the type of sleep data of the user.
   endTime: Contains the data for the start of sleep.
   created_at: Contains the data creation time.
   updated_at: Contains the data update time.
7. Sleep Deviation Data & Data fields used:
   app settings
   id: This is the primary key data.
   toleranceTime: Contains the deviation range data determined by the company.
8. Beta Data
   The data, instead of being stored in a physical space, is taken from the physical environment, processed, converted into JSON format, and transmitted to the Alpha user of the mobile application via the API.
9. Alpha Data
   The data, instead of being stored in a physical space, is taken from the physical environment, processed, converted into JSON format, and transmitted to the Beta user of the mobile application via the API.
10. Persona Group Data
   This data is planned to be created once a certain number of users is reached.

The data collected about the application's users typically includes demographic and behavioral characteristics such as age, gender, region of residence, and sleep patterns. This data is used to understand the general characteristics and behavioral tendencies of the users.

It is planned to create various user profiles or “persona” groups using the collected data. Persona groups represent the common behaviors of users with specific characteristics.
Data Analysis: The collected data is analyzed, and users with similar characteristics are grouped. For example, clusters are created based on age ranges, gender, and sleep habits.
Identifying Characteristics: The distinct characteristics of each persona group are defined. For example, groups like “Active and Social Users” or “Middle-aged, Family-oriented Users.”

Persona Descriptions: Detailed descriptions are made for each group. These descriptions include general characteristics, habits, and potential needs of the users.

When a new user starts using the application, the actions and behaviors of this user are tracked. This tracking is carried out with the following steps:
Behavioral Tracking: The user's daily actions and interactions are analyzed. For example, information such as the time periods when they are active is collected.
Profile Comparison: The data collected from the new user is compared with the characteristics of the existing persona groups. This comparison helps determine which persona group the user most closely matches.
Assignment to Persona Group: The user's characteristics and behaviors are assigned to the persona group they most closely match. This assignment is used to understand which group the user belongs to.

Creating persona groups and assigning users to these groups provides significant advantages in terms of application design and user experience. This method helps to better understand the users and offer them more suitable services. Additionally, by continuously monitoring and analyzing user behaviors, it enables persona groups to be updated and improved over time.
11. User Relations Data & Used Data Fields:
user_relations
   id: Primary key data.
   uuidBeta: The globally unique identifier of the Beta user.
   uuidAlpha: Contains the name information of the Alpha user.
   isActive: Contains information about whether the user relationship is active.
   created_at: Contains the data creation information.
   updated_at: Contains the data update information.
12. Interaction Data & Used Data Fields:
active types
   id: Primary key data.
   typeld: Key data for interaction type.
   description: Contains the description of the interaction.
   created_at: Contains the data creation information.
   updated_at: Contains the data update information.

### Algorithm & Working Methodology

A—Data Creation (step 1, SST1)
B—Deriving the Sleep Interval from Data (step 2, SST2)
C—Calculation of Alarm Durations (step 3, SST3)
D—Alarm Scenarios

### A—Creation of ACPER and SIPER Data (SST1 Initial Data):

The data group used to record the interaction information of users who use this application includes the start and end times of interactions with the mobile device throughout the day, as well as the types of interactions.

This data is triggered, processed within the application, and transmitted to the server via API when one of the specific interaction groups occurs on the mobile device. Here are the types of interactions, auxiliary data, and their explanations:

### Interaction Types:

Includes the events required to trigger mobile data.

### Active Types & TypeId & Description:

0|Currently Silent.
1|Phone was unlocked and used.
2|A call came, and the phone was answered.
3|A call came to the user, but they didn't answer.
4|User activated the screen but did not unlock it.

### SST1 Initial Data Creation Algorithm:

The initial data creation algorithm is performed by the alpha user's device (i.e. phone) and the result of the algorithm is transmitted to the server and is recorded at the server. As shown in FIG. 7, the initial data creation algorithm includes the following steps:
(1) The alpha user enter the night/day sleep intervals into the phone.
(2) The server gets the standard deviation set by the administrative user of the system (i.e. server administrator).
(3) The phone receive the user's night/day sleep intervals and transmits to the server, and the server calculate the standard deviation.
(4) The server determines operation successful.
(5) The server stores the sleep data.
(6) dynamic calculation by the server when the user updates the night/day sleep intervals or the administrative user updates the standard deviation.

To be more specific, the alpha device forms raw screen activation data list occurred by all types of screen activities. The raw screen activation data list is as shown below in Table 7-1.

TABLE 7-1
example of the raw screen activation data list

| screen | | | | |
|---|---|---|---|---|
| activity | device | | | |
| no | Id | User uuid number | startTime | endTime |
| 1 | 68898 | f12dbf08-4bc9-4625-81c7-57579485f3a4 | 8:00:00 | 8:01:22 |
| 2 | 68898 | f12dbf08-4bc9-4625-81c7-57579485f3a4 | 8:15:45 | 8:24:15 |
| 3 | 68898 | f12dbf08-4bc9-4625-81c7-57579485f3a4 | 9:12:00 | 9:30:11 |
| 4 | 68898 | f12dbf08-4bc9-4625-81c7-57579485f3a4 | 10:01:54 | 10:36:01 |
| 5 | 68898 | f12dbf08-4bc9-4625-81c7-57579485f3a4 | 11:18:12 | 11:24:52 |
| 6 | 68898 | f12dbf08-4bc9-4625-81c7-57579485f3a4 | 12:20:41 | 12:25:54 |
| 7 | 68898 | f12dbf08-4bc9-4625-81c7-57579485f3a4 | 13:24:00 | 13:35:23 |
| 8 | 68898 | f12dbf08-4bc9-4625-81c7-57579485f3a4 | 14:20:00 | 14:22:01 |
| 9 | 68898 | f12dbf08-4bc9-4625-81c7-57579485f3a4 | 14:42:21 | 14:43:24 |
| 10 | 68898 | f12dbf08-4bc9-4625-81c7-57579485f3a4 | 15:32:34 | 15:56:23 |

The alpha device further selects and refines qualified activities, for example, activity types 1: phone was unlocked and used, 2: a call came, and the phone was answered, and 4: user activated the screen but did not unlock it are selected as qualified activities by the alpha user and/or the server administrator. Table 7-2 below illustrates the activities being classified and selected.

TABLE 7-2
example of the selected qualified activities

| screen | | | | | | |
|---|---|---|---|---|---|---|
| activity | device | | | | Acitivity | Qualified |
| no | Id | User uuid number | startTime | endTime | types | Activities |
| 1 | 68898 | f12dbf08-4bc9-4625- | 8:00:00 | 8:01:22 | 4 | x |
| | | 81c7-57579485f3a4 | | | | |
| 2 | 68898 | f12dbf08-4bc9-4625- | 8:15:45 | 8:24:15 | 1 | x |
| | | 81c7-57579485f3a4 | | | | |
| 3 | 68898 | f12dbf08-4bc9-4625- | 9:12:00 | 9:30:11 | 2 | x |
| | | 81c7-57579485f3a4 | | | | |
| 4 | 68898 | f12dbf08-4bc9-4625- | 10:01:54 | 10:36:01 | 1 | x |
| | | 81c7-57579485f3a4 | | | | |
| 5 | 68898 | f12dbf08-4bc9-4625- | 11:18:12 | 11:24:52 | 1 | x |
| | | 81c7-57579485f3a4 | | | | |
| 6 | 68898 | f12dbf08-4bc9-4625- | 12:20:41 | 12:25:54 | 1 | x |
| | | 81c7-57579485f3a4 | | | | |
| 7 | 68898 | f12dbf08-4bc9-4625- | 13:24:00 | 13:35:23 | 1 | x |
| | | 81c7-57579485f3a4 | | | | |
| 8 | 68898 | f12dbf08-4bc9-4625- | 14:20:00 | 14:22:01 | 3 | |
| | | 81c7-57579485f3a4 | | | | |
| 9 | 68898 | f12dbf08-4bc9-4625- | 14:42:21 | 14:43:24 | 4 | x |
| | | 81c7-57579485f3a4 | | | | |
| 10 | 68898 | f12dbf08-4bc9-4625- | 15:32:34 | 15:56:23 | 1 | x |
| | | 81c7-57579485f3a4 | | | | |

After that, as shown in Table 7-3, the algorithm removes the non-qualified activities (i.e. activity type: 3) from the data.

TABLE 7-3
example of the non-qualified activities being removed

| | | | | | Qualified |
|---|---|---|---|---|---|
| screen | | | | | Acitivities |
| activity | device | | | | (No activity |
| no | Id | User uuid number | startTime | endTime | 3 anymore) |
| 1 | 68898 | f12dbf08-4bc9-4625-81c7- | 8:00:00 | 8:01:22 | 4 |
| | | 57579485f3a4 | | | |
| 2 | 68898 | f12dbf08-4bc9-4625-81c7- | 8:15:45 | 8:24:15 | 1 |
| | | 57579485f3a4 | | | |
| 3 | 68898 | f12dbf08-4bc9-4625-81c7- | 9:12:00 | 9:30:11 | 2 |
| | | 57579485f3a4 | | | |
| 4 | 68898 | f12dbf08-4bc9-4625-81c7- | 10:01:54 | 10:36:01 | 1 |
| | | 57579485f3a4 | | | |
| 5 | 68898 | f12dbf08-4bc9-4625-81c7- | 11:18:12 | 11:24:52 | 1 |
| | | 57579485f3a4 | | | |
| 6 | 68898 | f12dbf08-4bc9-4625-81c7- | 12:20:41 | 12:25:54 | 1 |
| | | 57579485f3a4 | | | |
| 7 | 68898 | f12dbf08-4bc9-4625-81c7- | 13:24:00 | 13:35:23 | 1 |
| | | 57579485f3a4 | | | |
| 9 | 68898 | f12dbf08-4bc9-4625-81c7- | 14:42:21 | 14:43:24 | 4 |
| | | 57579485f3a4 | | | |
| 10 | 68898 | f12dbf08-4bc9-4625-81c7- | 15:32:34 | 15:56:23 | 1 |
| | | 57579485f3a4 | | | |

### Obtaining Sleep Data:

The deviation value set by the company (i.e. server administrator) will be used to calculate the standard deviation range of the sleep times that Beta users determine for Alpha users. This calculation is planned to be integrated into the data collected from persona groups in the future. This process aims to improve the accuracy and precision of the data.

### Max Sleep Time:

The maximum sleep time defined by the company determines the highest value that Alpha user's sleep data can reach. This limit triggers the alarm system when the night sleep duration exceeds this value. In other words, if the inactivity falls within the night sleep intervals but the sleep duration exceeds the maximum sleep time, the alarm will ring. In this case, by adding (or subtracting) the standard deviation to the start time of the sleep and then adding the maximum sleep duration, this new value is fixed as the “max sleep time” and is checked during data creation.

### Algorithm for Creating Siper and Acper Data:

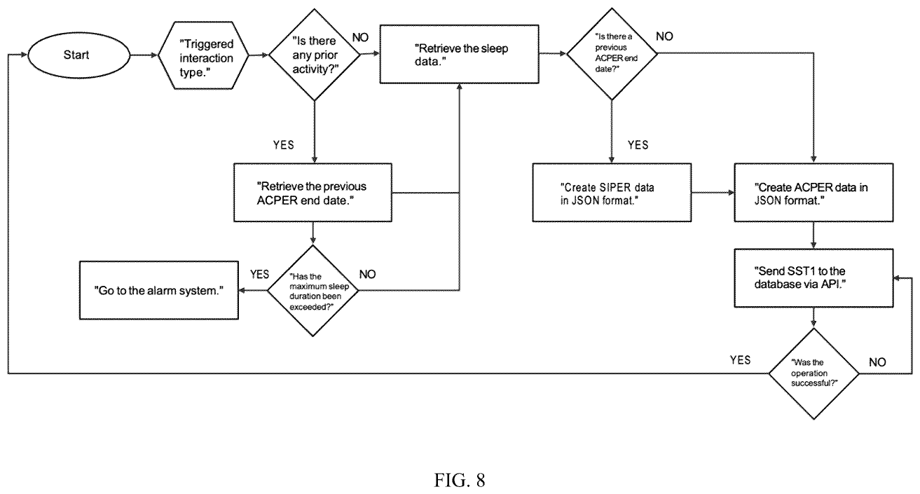

After this process, as shown in FIG. 8, the interactions performed by Alpha users with the mobile device are separated as “acper” and “siper,” and recorded on the physical server through the mobile device's API service. The start and end dates of the data are converted to timestamp format. For every two “acper” data entries, one “siper” data is created, which is collected to determine how long the user was not interacting with the mobile device. The collected siper data is stored for use in the next process, SST2.

### B—SST2 Sleep Hours Derivation Algorithm

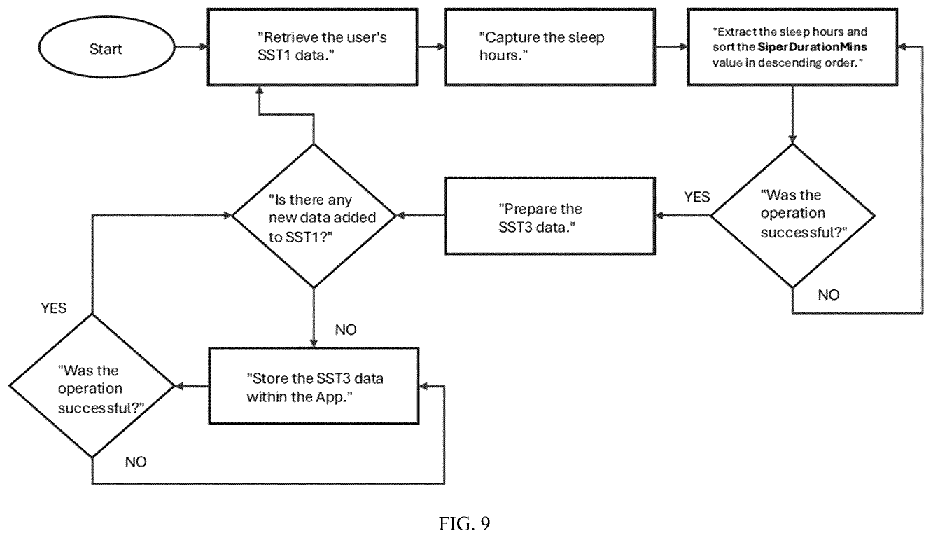

FIG. 9 illustrates a float chart of a sleep hours derivation algorithm. The user's SST1 data is retrieved from the alpha's phone and the sleep hours information is captured.

In specific, the server determines whether these qualified activities are within the sleep period, as shown in Table 7-4.

TABLE 7-4
example of the determination about whether qualified
activities being in the sleep period

| | | | | | | In the |
|---|---|---|---|---|---|---|
| screen | | | | | | sleep |
| activity | device | | | | Qualified | period |
| no | Id | User uuid number | startTime | endTime | Acitivities | sleeping |
| 1 | 68898 | f12dbf08-4bc9-4625- | 8:00:00 | 8:01:22 | 4 | FALSE |
| | | 81c7-57579485f3a4 | | | | |
| 2 | 68898 | f12dbf08-4bc9-4625- | 8:15:45 | 8:24:15 | 1 | FALSE |
| | | 81c7-57579485f3a4 | | | | |
| 3 | 68898 | f12dbf08-4bc9-4625- | 9:12:00 | 9:30:11 | 2 | FALSE |
| | | 81c7-57579485f3a4 | | | | |
| 4 | 68898 | f12dbf08-4bc9-4625- | 10:01:54 | 10:36:01 | 1 | FALSE |
| | | 81c7-57579485f3a4 | | | | |
| 5 | 68898 | f12dbf08-4bc9-4625- | 11:18:12 | 11:24:52 | 1 | FALSE |
| | | 81c7-57579485f3a4 | | | | |
| 6 | 68898 | f12dbf08-4bc9-4625- | 12:20:41 | 12:25:54 | 1 | FALSE |
| | | 81c7-57579485f3a4 | | | | |
| 7 | 68898 | f12dbf08-4bc9-4625- | 13:24:00 | 13:35:23 | 1 | FALSE |
| | | 81c7-57579485f3a4 | | | | |
| 9 | 68898 | f12dbf08-4bc9-4625- | 14:42:21 | 14:43:24 | 4 | FALSE |
| | | 81c7-57579485f3a4 | | | | |
| 10 | 68898 | f12dbf08-4bc9-4625- | 15:32:34 | 15:56:23 | 1 | FALSE |
| | | 81c7-57579485f3a4 | | | | |
| 11 | 68898 | f12dbf08-4bc9-4625- | 17:23:33 | 17:43:21 | 2 | FALSE |
| | | 81c7-57579485f3a4 | | | | |
| 12 | 68898 | f12dbf08-4bc9-4625- | 19:33:21 | 20:01:23 | 2 | FALSE |
| | | 81c7-57579485f3a4 | | | | |
| 13 | 68898 | f12dbf08-4bc9-4625- | 21:20:12 | 21:21:13 | 4 | FALSE |
| | | 81c7-57579485f3a4 | | | | |
| 14 | 68898 | f12dbf08-4bc9-4625- | 22:04:12 | 22:14:34 | 1 | TRUE |
| | | 81c7-57579485f3a4 | | | | |
| 15 | 68898 | f12dbf08-4bc9-4625- | 0:03:23 | 0:06:01 | 1 | TRUE |
| | | 81c7-57579485f3a4 | | | | |
| 16 | 68898 | f12dbf08-4bc9-4625- | 3:12:34 | 3:13:30 | 4 | TRUE |
| | | 81c7-57579485f3a4 | | | | |
| 17 | 68898 | f12dbf08-4bc9-4625- | 6:15:32 | 6:15:45 | 4 | TRUE |
| | | 81c7-57579485f3a4 | | | | |

After that, a net active periods list is obtained by the server by removing the qualified activities in the sleep period, as shown in Table 7-5 below.

TABLE 7-5
example of the net active periods list

| | | | | | | In the |
|---|---|---|---|---|---|---|
| screen | | | | | | sleep |
| activity | device | | | | Qualified | period |
| no | Id | User uuid number | startTime | endTime | Acitivities | sleeping |
| 1 | 68898 | f12dbf08-4bc9-4625- | 8:00:00 | 8:01:22 | 4 | FALSE |
| | | 81c7-57579485f3a4 | | | | |
| 2 | 68898 | f12dbf08-4bc9-4625- | 8:15:45 | 8:24:15 | 1 | FALSE |
| | | 81c7-57579485f3a4 | | | | |
| 3 | 68898 | f12dbf08-4bc9-4625- | 9:12:00 | 9:30:11 | 2 | FALSE |
| | | 81c7-57579485f3a4 | | | | |
| 4 | 68898 | f12dbf08-4bc9-4625- | 10:01:54 | 10:36:01 | 1 | FALSE |
| | | 81c7-57579485f3a4 | | | | |
| 5 | 68898 | f12dbf08-4bc9-4625- | 11:18:12 | 11:24:52 | 1 | FALSE |
| | | 81c7-57579485f3a4 | | | | |
| 6 | 68898 | f12dbf08-4bc9-4625- | 12:20:41 | 12:25:54 | 1 | FALSE |
| | | 81c7-57579485f3a4 | | | | |
| 7 | 68898 | f12dbf08-4bc9-4625- | 13:24:00 | 13:35:23 | 1 | FALSE |
| | | 81c7-57579485f3a4 | | | | |
| 9 | 68898 | f12dbf08-4bc9-4625- | 14:42:21 | 14:43:24 | 4 | FALSE |
| | | 81c7-57579485f3a4 | | | | |
| 10 | 68898 | f12dbf08-4bc9-4625- | 15:32:34 | 15:56:23 | 1 | FALSE |
| | | 81c7-57579485f3a4 | | | | |
| 11 | 68898 | f12dbf08-4bc9-4625- | 17:23:33 | 17:43:21 | 2 | FALSE |
| | | 81c7-57579485f3a4 | | | | |
| 12 | 68898 | f12dbf08-4bc9-4625- | 19:33:21 | 20:01:23 | 2 | FALSE |
| | | 81c7-57579485f3a4 | | | | |
| 13 | 68898 | f12dbf08-4bc9-4625- | 21:20:12 | 21:21:13 | 4 | FALSE |
| | | 81c7-57579485f3a4 | | | | |
| 18 | 68898 | f12dbf08-4bc9-4625- | 8:01:22 | 8:03:34 | 1 | FALSE |
| | | 81c7-57579485f3a4 | | | | |
| 19 | 68898 | f12dbf08-4bc9-4625- | 8:15:23 | 8:30:23 | 1 | FALSE |
| | | 81c7-57579485f3a4 | | | | |
| 20 | 68898 | f12dbf08-4bc9-4625- | 9:12:22 | 9:23:01 | 1 | FALSE |
| | | 81c7-57579485f3a4 | | | | |

Then, silent periods are obtained by the server based on the time ranges in between the active periods (i.e. in between the activities), as shown in Table 7-6 below. The SiperDurationMins value is obtained. The SiperDurationMins value represents the duration of the alpha user being inactive during non-sleep hours.

TABLE 7-6
example of the net active periods list

| | | | | | | | Calculated |
|---|---|---|---|---|---|---|---|
| screen | | | Net | | | Net | Net Siper |
| activity | device | | Acper | Start | End | Siper | Duration |
| no | Id | User uuid number | No | Time | Time | No | Mins |
| 1 | 68898 | f12dbf08-4bc9- | 1 | 8:00:00 | 8:01:22 | 1 | 0:14:23 |
| | | 4625-81c7- | | | | | |
| | | 57579485f3a4 | | | | | |
| 2 | 68898 | f12dbf08-4bc9- | 2 | 8:15:45 | 8:24:15 | 2 | 0:47:45 |
| | | 4625-81c7- | | | | | |
| | | 57579485f3a4 | | | | | |
| 3 | 68898 | f12dbf08-4bc9- | 3 | 9:12:00 | 9:30:11 | 3 | 0:31:43 |
| | | 4625-81c7- | | | | | |
| | | 57579485f3a4 | | | | | |
| 4 | 68898 | f12dbf08-4bc9- | 4 | 10:01:54 | 10:36:01 | 4 | 0:42:11 |
| | | 4625-81c7- | | | | | |
| | | 57579485f3a4 | | | | | |
| 5 | 68898 | f12dbf08-4bc9- | 5 | 11:18:12 | 11:24:52 | 5 | 0:55:49 |
| | | 4625-81c7- | | | | | |
| | | 57579485f3a4 | | | | | |
| 6 | 68898 | f12dbf08-4bc9- | 6 | 12:20:41 | 12:25:54 | 6 | 0:58:06 |
| | | 4625-81c7- | | | | | |
| | | 57579485f3a4 | | | | | |
| 7 | 68898 | f12dbf08-4bc9- | 7 | 13:24:00 | 13:35:23 | 7 | 1:06:58 |
| | | 4625-81c7- | | | | | |
| | | 57579485f3a4 | | | | | |
| 9 | 68898 | f12dbf08-4bc9- | 8 | 14:42:21 | 14:43:24 | 8 | 0:49:10 |
| | | 4625-81c7- | | | | | |
| | | 57579485f3a4 | | | | | |
| 10 | 68898 | f12dbf08-4bc9- | 9 | 15:32:34 | 15:56:23 | 9 | 1:27:10 |
| | | 4625-81c7- | | | | | |
| | | 57579485f3a4 | | | | | |
| 11 | 68898 | f12dbf08-4bc9- | 10 | 17:23:33 | 17:43:21 | 10 | 1:50:00 |
| | | 4625-81c7- | | | | | |
| | | 57579485f3a4 | | | | | |

C—SST3 Determination of Alarm Duration and Sharpness—Sensitivity (sensitiveLvl)

### Process 1:

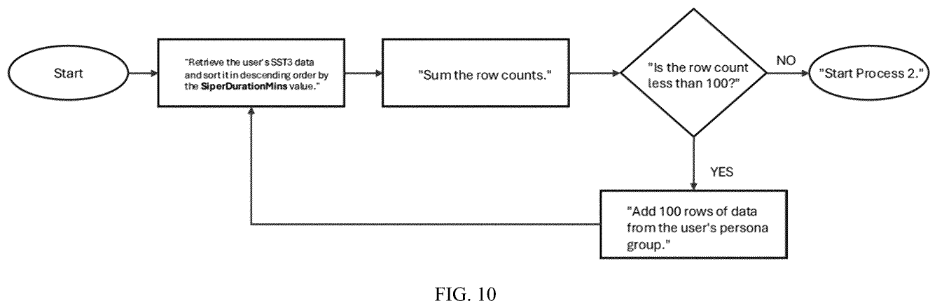

As shown in FIG. 10, the siperDurationMins values of Alpha users are sorted in descending order, and the total number of rows in the sorted data is calculated. If this total row count is less than 100, 100 additional data points are retrieved from the persona groups assigned to the users, along with the existing data. With these additional data points, the sorting is redone in descending order according to the siperDurationMins value. FIG. 10 defines these operations.

### Process 2:

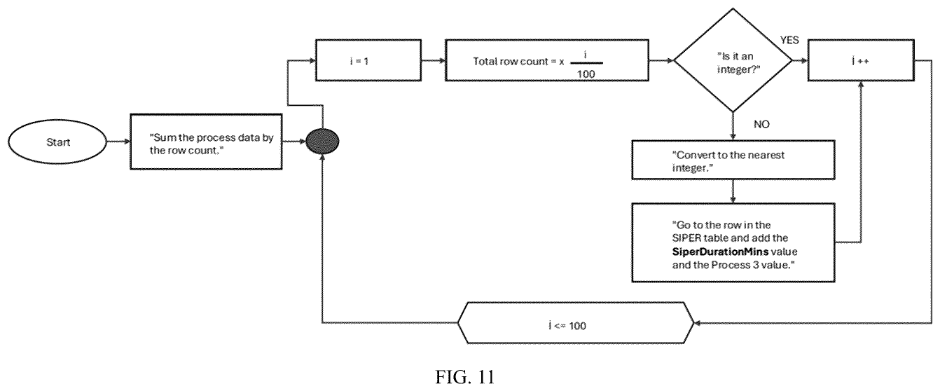

At this stage, as shown in FIG. 11, the siper data consisting of more than 100 rows is divided into percentiles according to the row count. The goal is to calculate the average values of the determined percentiles and trigger the alert system based on the sensitivity value set by the Beta user, according to the Alpha user's siperDurationMins average.

As the data increases in each siper entry, the percentile average value of the sensitivity becomes dynamic. For this reason, the interaction data with the mobile application changes dynamically according to the user. This situation allows for the sensitivity level to be increased or decreased.

For example, for 184 rows of siper data:
Determining the Total Number of Rows: Contains 184 rows.
Calculating the Percentile Row Count: To determine 1% of the data:
Percentile Row Count=Total Row Count× 1/100
Percentile Row Count=184×0.01=1.84

Since the row count must be a whole number, 1.84 is rounded to the nearest integer. In this case, 1% corresponds to 2 rows.

In FIG. 11, the total number of rows is taken, and the process continues until 100% percentiles are completed, resulting in the following data Table 7-7:

TABLE 7-7
Sensitivity Data Table

| Percentile | Siper Line | Siper Duration |
|---|---|---|
| (%) | Number | Mins |
| %1 | 2 | 120 |
| %2 | 4 | 110 |
| %3 | 6 | 100 |
| %4 | 8 | 90 |
| %5 | 10 | 80 |
| %6 | 12 | 70 |
| %7 | 14 | 60 |
| %8 | 16 | 50 |
| %9 | 18 | 45.5 |
| %10 | 20 | 40.25 |
| %20 | 36 | 35.33 |
| %30 | 55 | 30.17 |
| %40 | 74 | 27.08 |
| %50 | 92 | 24.75 |
| %60 | 111 | 21.5 |
| %70 | 130 | 18.33 |
| %80 | 149 | 15.17 |
| %90 | 168 | 12.42 |
| %99 | 182 | 9.25 |
| %100 | 184 | 6.08 |

In this case, the Shield Row Number and shield Duration Mins values are sorted from largest to smallest in the previous Process 1, so the shield DurationMins value is in the 2nd highest row position.

### Process 3:

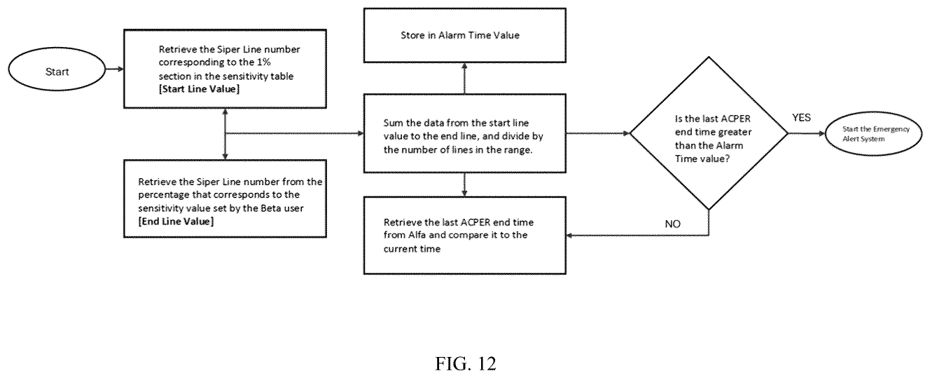

As shown in FIG. 12, the sensitivity value that the Alpha user will determine for the Beta user is set to correspond to the percentile portions of the data defined above.

For example, the following table is for sensitivity values.

TABLE 7-8
Pre-set Sensitivity Levels Table

| Sensitivity | | |
|---|---|---|
| level | Percentile | Sensitivity Value |
| Low | %10 | Sum of the data from the 2nd row to the 20th |
| | | row, divided by the number of rows in the range. |
| | %30 | Sum of the data from the 2nd row to the 55th |
| | | row, divided by the number of rows in the range. |
| Medium | %50 | Sum of the data from the 2nd row to the 92nd |
| | | row, divided by the number of rows in the range. |
| | %60 | Sum of the data from the 2nd row to the 111th |
| | | row, divided by the number of rows in the range. |
| High | %80 | Sum of the data from the 2nd row to the 149th |
| | | row, divided by the number of rows in the range. |

Medium: Sensitivity evaluation at moderate intervals in the 50% and 60% percentiles.
High: Sensitivity evaluation at a wider interval in the 80% percentile.

These table values can be modified by system administrators.

To be more specific, the company management (i.e. the server administrator) defines a pre-set number of sensitivity levels (in the example, five sensitivity levels are defined, however, it is noted that the server administrator can define any number of sensitivity levels for others to choose from), and each is assigned with a percentile value. The alpha, beta, and/or omega users can select one of the pre-set sensitivity levels based on their needs and cause the alarm to be triggered based on different lengths of the inactivity times (i.e. adjust the sensitivity of the alarm).

### D—Alarm Scenarios

As illustrated in FIG. 12, the time elapsed since the last activity of the Alpha user is evaluated by the server based on the sensitivity level set by the Beta user. If this time exceeds the set sensitivity level, it is assumed that the Alpha user may need help, and the Emergency Warning System is activated, starting the following scenarios:

### Scenario 1:

The system first checks the status of the Alpha user. A notification is sent to the Alpha user via the app, and information about their condition is requested. If the Alpha user confirms they are fine, this is recorded as an activity, and the alarm is stopped. However, the Beta user is informed of the developments in the notification area without triggering an alarm.

### Scenario 2:

If the Alpha user indicates through the app notification that they need help, the emergency scenario is activated, sending emergency notifications sequentially to Omega and Beta users. The app continues sending notifications until either Omega or Beta clicks the “checking the situation” button. If responses to the app notifications are not received, Omega and Beta users are contacted via SMS.

### Scenario 3:

If the Alpha user does not respond within the specified time, the Emergency Warning System sends notifications to Omega and Beta users sequentially. If no response is received to the app notifications, Omega and Beta users are contacted via SMS.

### Scenario 4:

If the Alpha user presses the manual emergency activation button on the app, a screen appears for 10 seconds, allowing them to cancel this request. If the cancel button is not pressed within this time, an emergency scenario bypassing the algorithm's calculated time is activated. The Emergency Warning System sends notifications to Omega and Beta users sequentially. If no response is received to the app notifications, Omega and Beta users are contacted via SMS.

It is noted that the processes of A to D (i.e. data creation, deriving the sleep interval, calculation of alarm durations, and alarm triggering) are continuously repeated processes. Therefore, a change of the sleep interval, standard deviation, qualified activities, pre-set number of sensitivity levels, the selected sensitivity level, and/or all other parameters included in the processes would result in a dynamic adjustment of how and when the alarms are triggered, therefore allowing the users (including alpha, beta, and omega) to dynamically adjust the alarm system in real-time based on their current situations and needs.

What is claimed is:

1. An emergency system, comprising:
a processor,
a memory, and
a non-transitory computer readable medium storing computer instructions, when the computer instructions are executed by the processor, cause the emergency system to:
obtain usage information of a mobile device by communicating with the mobile device;
obtain geolocation information of the mobile device by communicating with the mobile device;
determine a type of inactivity of the mobile device and an associated duration of inactivity of the mobile device;
determine the duration of inactivity of the mobile device exceed one of a predetermined inactivity duration thresholds;
determine a geolocation of the mobile device being inside or outside of a predetermined geolocation range;
determine a duration of the geolocation of the mobile device being inside or outside of the predetermined geolocation range exceed one of a predetermined geolocation duration thresholds; and
transmit a notification to the mobile device based on the type of inactivity of the mobile device, the predetermined inactivity duration threshold being exceed, the geolocation of the mobile device being inside or outside of the predetermined geolocation range, and the predetermined geolocation duration threshold being exceeded.

2. The emergency system according to claim 1, wherein the notification comprises text and voice messages.

3. The emergency system according to claim 2, wherein the predetermined inactivity duration thresholds and the predetermined geolocation duration thresholds are each assigned with an importance level, a type of notification, and a notification color.

4. The emergency system according to claim 1, wherein the emergency system is further configured to:
obtain a list of contacts set by a user of the mobile device; and
transmit a second notification to a contact of the list of contacts in response to the predetermined inactivity duration threshold being exceed or the predetermined geolocation duration threshold being exceeded is a predetermined threshold indicating that the user of the mobile device needs assistance.

5. The emergency system according to claim 1, wherein the emergency system is further configured to:
transmit a second notification to an official institution in response to the predetermined inactivity duration threshold being exceed or the predetermined geolocation duration threshold being exceeded is a predetermined threshold indicating that a user of the mobile device needs immediate assistance.

6. The emergency system according to claim 1, wherein the emergency system is further configured to:
obtain a list of contacts set by a user of the mobile device; and
receive a communication from the mobile device that a help button on the mobile device is pressed;
in response to the communication that the help button on the mobile device is pressed, transmit a notification to a contact in the list of contacts indicating a danger situation;
receive a communication from the mobile device that the help button on the mobile device is pressed twice consecutively;
in response to the communication that the help button on the mobile device is pressed twice consecutively, establish a group call to all contacts in the list of contacts;
receive a communication from the mobile device that the help button on the mobile device is pressed three times consecutively; and
in response to the communication that the help button on the mobile device is pressed three times consecutively, automatically call an official institution by playing an pre-recorded voice message informing the official institution that the user needs immediate assistance.

7. The emergency system according to claim 1, wherein the predetermined inactivity duration thresholds are based on an awake time frame, an asleep time frame, an awake non-use time, an asleep non-use time, an awake emergency non-use time, and an asleep emergency non-use time; and
wherein the awake time frame, the asleep time frame, the awake non-use time, the asleep non-use time, the awake emergency non-use time, and the asleep emergency non-use time are set by a user of the mobile device.

8. The emergency system according to claim 7, wherein the emergency system is further configured to:
obtain sleep data from the mobile device indicating a sleep schedule of the user of the mobile device;
extract SIPER data and ACPER data from the sleep data, wherein the SPIER data indicates time ranges that there is no interaction between the user and the mobile device, and wherein the ACPER data indicates time ranges that there is interaction between the user and the mobile device;
determine whether one of the predetermined inactivity duration thresholds is exceed and transmit the notification based on the SIPER data and ACPER data.

9. The emergency system according to claim 8, wherein the emergency system is further configured to:
obtain a list of contacts set by a user of the mobile device; and
adjust the sleep data based on a standard deviation range of sleep times preset by a contact within the list of contacts.

10. The emergency system according to claim 9, wherein the emergency system is further configured to:
obtain a sensitivity level set by a contact within the list of contacts;
adjust the predetermined inactivity duration thresholds based on the sensitivity level set by the contact.

11. An emergency method, performed by an emergency system comprising a processor, a memory, and a non-transitory computer readable medium storing computer instructions, the method comprising:
obtaining usage information of a mobile device by communicating with the mobile device;
obtaining geolocation information of the mobile device by communicating with the mobile device;
determining a type of inactivity of the mobile device and an associated duration of inactivity of the mobile device;
determining the duration of inactivity of the mobile device exceed one of a predetermined inactivity duration thresholds;
determining a geolocation of the mobile device being inside or outside of a predetermined geolocation range;
determining a duration of the geolocation of the mobile device being inside or outside of the predetermined geolocation range exceed one of a predetermined geolocation duration thresholds; and
transmitting a notification to the mobile device based on the type of inactivity of the mobile device, the predetermined inactivity duration threshold being exceed, the geolocation of the mobile device being inside or outside of the predetermined geolocation range, and the predetermined geolocation duration threshold being exceeded.

12. The emergency method according to claim 11, wherein the notification comprises text and voice messages.

13. The emergency method according to claim 12, wherein the predetermined inactivity duration thresholds and the predetermined geolocation duration thresholds are each assigned with an importance level, a type of notification, and a notification color.

14. The emergency method according to claim 11, further comprising:
obtaining a list of contacts set by a user of the mobile device; and
transmitting a second notification to a contact of the list of contacts in response to the predetermined inactivity duration threshold being exceed or the predetermined geolocation duration threshold being exceeded is a predetermined threshold indicating that the user of the mobile device needs assistance.

15. The emergency method according to claim 11, further comprising:
transmit a second notification to an official institution in response to the predetermined inactivity duration threshold being exceed or the predetermined geolocation duration threshold being exceeded is a predetermined threshold indicating that a user of the mobile device needs immediate assistance.

16. The emergency method according to claim 11, further comprising:
obtaining a list of contacts set by a user of the mobile device; and
receiving a communication from the mobile device that a help button on the mobile device is pressed;
in response to the communication that the help button on the mobile device is pressed, transmitting a notification to a contact in the list of contacts indicating a danger situation;
receiving a communication from the mobile device that the help button on the mobile device is pressed twice consecutively;
in response to the communication that the help button on the mobile device is pressed twice consecutively, establishing a group call to all contacts in the list of contacts;
receiving a communication from the mobile device that the help button on the mobile device is pressed three times consecutively; and
in response to the communication that the help button on the mobile device is pressed three times consecutively, automatically calling an official institution by playing a pre-recorded voice message informing the official institution that the user needs immediate assistance.

17. The emergency method according to claim 11, wherein the predetermined inactivity duration thresholds are based on an awake time frame, an asleep time frame, an awake non-use time, an asleep non-use time, an awake emergency non-use time, and an asleep emergency non-use time; and
wherein the awake time frame, the asleep time frame, the awake non-use time, the asleep non-use time, the awake emergency non-use time, and the asleep emergency non-use time are set by a user of the mobile device.

18. The emergency method according to claim 17, further comprising:
obtaining sleep data from the mobile device indicating a sleep schedule of the user of the mobile device;
extracting SIPER data and ACPER data from the sleep data, wherein the SPIER data indicates time ranges that there is no interaction between the user and the mobile device, and wherein the ACPER data indicates time ranges that there is interaction between the user and the mobile device;
determining whether one of the predetermined inactivity duration thresholds is exceed and transmit the notification based on the SIPER data and ACPER data.

19. The emergency method according to claim 18, further comprising:
obtaining a list of contacts set by a user of the mobile device; and
adjusting the sleep data based on a standard deviation range of sleep times preset by a contact within the list of contacts.

20. The emergency method according to claim 19, further comprising:
obtaining a sensitivity level set by a contact within the list of contacts;
adjusting the predetermined inactivity duration thresholds based on the sensitivity level set by the contact.
